(19) United States
(12) Patent Application Publication
(10) Pub. No.: US 2011/0228829 A1
(43) Pub. Date: Sep. 22, 2011

(54) SYSTEM AND METHOD OF RADIO CHANNEL MANAGEMENT IN A WIRELESS NETWORK

(75) Inventors: Roman Kazarnovski, Modi'in (IL); Tal Gamburg, Jerusalem (IL); Haim Yashar, Tel Aviv (IL)

(73) Assignee: TCM MOBILE LLC, NEW YORK, NY (US)

(21) Appl. No.: 12/859,577

(22) Filed: Aug. 19, 2010

Related U.S. Application Data
(60) Provisional application No. 61/235,380, filed on Aug. 20, 2009.

(51) Int. Cl. H04L 5/16

(52) U.S. Cl. 375/220

(57) ABSTRACT

A method and system for management of radio frequency channels in a wireless communications network including at least one access point and at least one mobile device coupled for wireless communication to the access point, the method including periodically generating a transmission channel testing scenario which includes a plurality of transmission channels for testing by the access point; transmitting data between the access point and said mobile device over each transmission channel according to the scenario; testing Quality of Service (QoS) parameters in the access point and the mobile device over each said transmission channel; determining a transmission channel from the scenario having best QoS parameters; and reconfiguring the access point to transmit on the transmission channel having best QoS parameters.

### CROSS-REFERENCE TO RELATED APPLICATION

This application claims the benefit of U.S. provisional application No. 61/235,380, filed Aug. 20, 2009.

### FIELD OF THE INVENTION

The present invention relates to the field of wireless networks, and more particularly to management of radio channel frequencies used in such networks.

### BACKGROUND OF THE INVENTION

Management of radio channels is one of the main problems of Spread Spectrum systems management, at present. In general access systems, the usage of recommended rigid radio frequency tuning is almost impossible, due to the existence of external radio sources in the designated coverage area. Even if, during the process of radio network deployment, mutual radio interference was minimized or neutralized, there is no assurance that the situation of the radio channels in use will not change after some period of time, due to various factors, like the appearance of new sources of radio signals or change in tuning of existing sources.

Thus, operators of wireless communications networks have no control over the location and operating channels of potentially conflicting networks that may be set up by others within their coverage area. Accordingly, interference problems may arise which can adversely affect their quality of service.

### SUMMARY OF THE INVENTION

The present invention relates to a method and system for selecting optimal radio frequency (RF) channels for access points in a wireless communication network according to current network conditions. This is accomplished by providing one or more mobile devices in the network with a software application which permits the mobile devices to operate in three modes—a first, conversation mode, for conventional communication over the access network, a second, active sensor mode, in which the mobile devices collect data relating to the transmission parameters, e.g., radio frequency and Quality of Service data from their environment and provide this data to an auto-correction server coupled to the access points in the vicinity of the mobile devices, and a third, passive mode, in which the mobile devices collect data relating to nearby access points, e.g., identification, channel and signal strength from the adjacent access points. The auto-correction server provides post-processing of the data and calculates, from the collected data, an optimal RF channel over which each access point to which it is coupled should operate, given the current network conditions.

### BRIEF DESCRIPTION OF THE DRAWINGS

The present invention will be further understood and appreciated from the following detailed description taken in conjunction with the drawings in which:

FIG. 1 is a schematic illustration of a wireless communication network, constructed and operative in accordance with one embodiment of the present invention;

FIG. 2 is a schematic illustration of the wireless communication network of FIG. 1, with the addition of external radio sources creating some level of interference with access points within the network;

FIG. 3 is a schematic illustration of the wireless communication network of FIG. 2, with additional external radio sources;

FIG. 4 is a chart illustrating a method of radio channel auto-correction, constructed and operative in accordance with one embodiment of the present invention; and

FIG. 5 is a reference schematic diagram illustrating radio channels in a conventional ISM 2.4 GHz band.

### DETAILED DESCRIPTION OF THE INVENTION

The present invention relates to a radio frequency (RF) management system and method for wireless communication networks, for example, networks that follow the IEEE 802.1* protocol, like WiFi or WiMAX® systems. The method permits auto-correction of channel selection and/or change of transmission power and/or change of any other parameter, such as RTP (Realtime Transport Protocol), ACK TIMEOUT etc., by the access points in the network. In order to determine the optimum transmission parameters, particularly channel frequencies, for each of the access points, a consecutive examination procedure is used. The procedure is based on radio station and active and passive sensor data monitoring, as described below.

The system, also referred to herein as a wireless network, includes a plurality of access points for providing access communication within a defined sector to a plurality of mobile devices, a local or regional auto-correction server, which can be an independent device mounted remotely from and coupled to the access points or can be a module mounted inside one or more access points, coupled to the mobile devices, a plurality of mobile devices including a software application permitting activation of the mobile device by the local auto-correction server, and an optional central auto-correction server coupled to several local auto-correction servers.

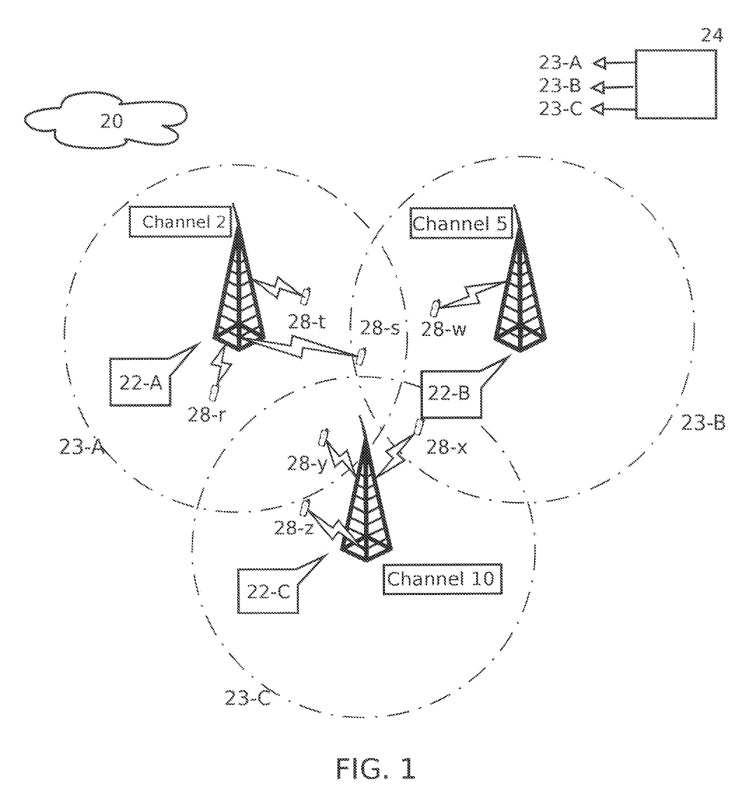

FIG. 1 shows a wireless network 20, in accordance with one embodiment of the present invention. The illustrated network 20 has three wireless access points 22 and a local auto-correction server 24 with a Data Base Management System (DBMS) installed. For convenient identification, the individual access points 22 have been designated 22A, 22B, and 22C. Each access point 22 includes a transceiver capable of transmitting and receiving wireless signals within a specified range or distance 23. Local auto-correction server 24 is coupled for two-way communication to access points 22. Communication between local auto-correction server 24 and access points 22 may be a wired or wireless connection, and generally allows for secure and reliable communication between server 24 and each access point 22. Preferably, the local auto-correction server 24 has a Data Base Management System (DBMS) for accessing and storing data in the server.

FIG. 1 also shows a plurality of mobile devices or clients 28. Seven mobile devices are shown in the figure, and are designated 28r, 28s, 28t, 28w, 28x, 28y, and 28z, for convenient identification. The mobile devices 28 contain the appropriate hardware and software components to enable conventional wireless communication with access points 22. In addition, mobile devices 28 further include a software application (e.g., a driver) and/or hardware components (not shown) that enable them to communicate with and receive instructions from local auto correction server 24 permitting them to operate, in an active sensor mode, as independent units, as described below, and in a passive sensor mode to transfer data relating to nearby access points to the local auto-correction server, rather than acting merely as terminals in a cellular network.

In some embodiments of the invention, network 20 may be configured so as to provide a seamless or uninterrupted “handoff” from one access point 22 to another, as mobile device 28 roams within the region served by network 20. For example, mobile device 28r may be a PDA or laptop computer or any other device with WiFi/WiMAX® capability, providing a voice conversation using VoIP (voice over IP) or any other data services. Initially, communication may be with access point 22A, which is initially the closest access point 22, as shown in FIG. 1. As the user moves away from access point 22A and towards access point 22C, for example, communication may switch from access point 22A to access point 22C. In this way, wireless network 20 functions in a similar fashion as a conventional cellular communication network. One example of suitable technology is further described in U.S. Pat. No. 7,406,069, for A Wireless Packet Communication System and Method, to the same assignee, which is incorporated herein by reference.

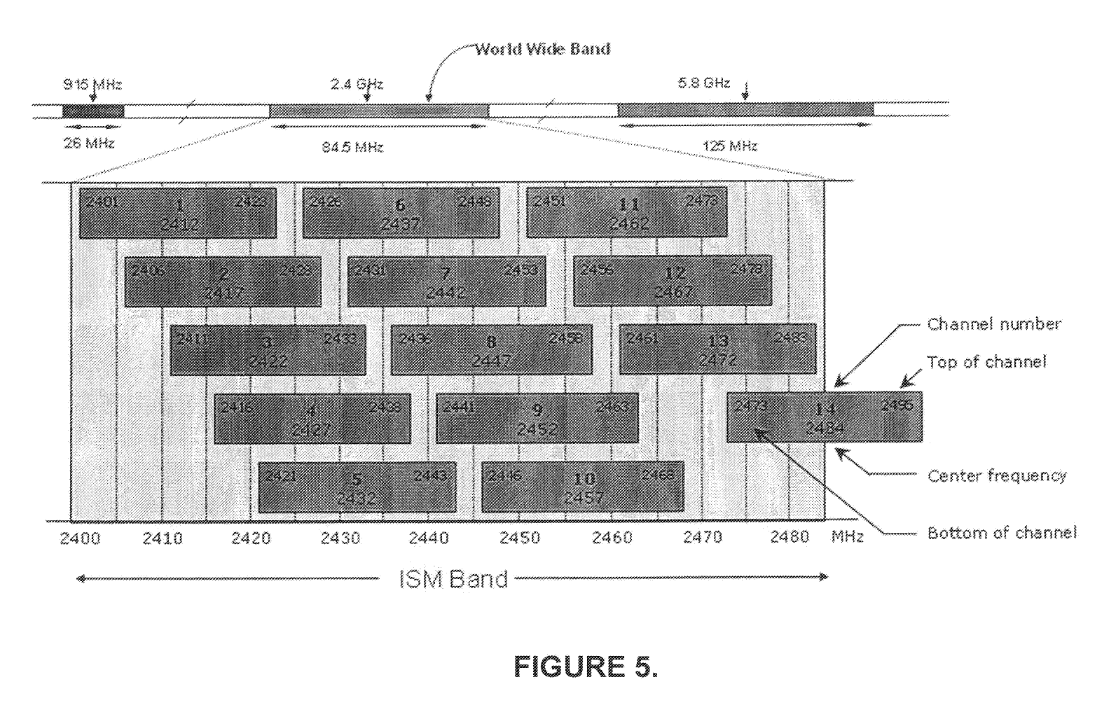

The transmission frequency band or channel and other transmission parameters used by each access point 22 are generally selected to minimize interference with the channels used by adjacent access points 22 in network 20. By way of example, an initial or preliminary network configuration assigns substantially non-overlapping channels to adjacent access points. Thus, the preliminary configuration may have access point 22A using channel 2, access point 22B using channel 5, and access point 22C using channel 10, in the WiFi 2.4 GHz band, as shown in FIG. 1. For further reference, FIG. 5 is provided to show a graphical representation of WiFi channels in the 2.4 GHz band. As indicated, channel 10 does not overlap either with channel 2 or channel 5. Channels 2 and 5 overlap slightly at their respective edges, but not at their center, and are accordingly considered to have a reasonably low level of interference.

As discussed further below, each mobile device 28 will communicate with the access point 22 that is closest and/or that provides the best quality signal. Accordingly, in FIG. 1, mobile devices 28r, 28s, and 28t are shown communicating with access point 22A, mobile device 28w is shown communicating with access point 22B, and mobile devices 28x, 28y, and 28z communicate with access point 22C.

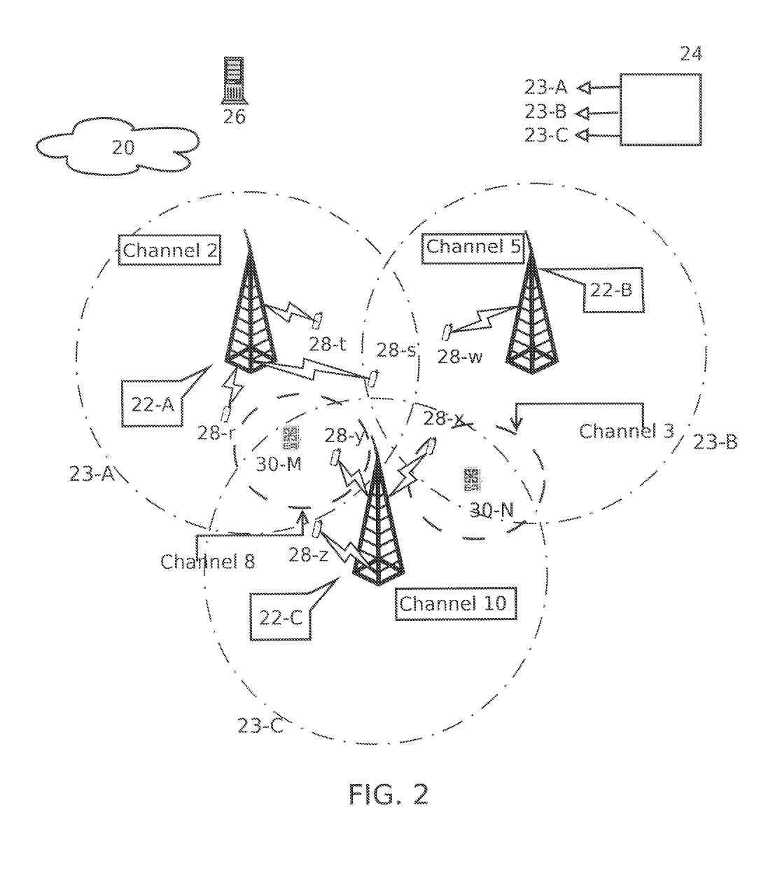

FIG. 2 shows the system of FIG. 1 when new external radio sources 30 have entered the coverage area of network 20, here illustrated as radio source 30M and radio source 30N. Radio sources 30 can be, for example, access points that are not part of wireless network 20. Radio sources 30 may include any external radio sources, such as any transmitting access points, repeaters, clients, or other types of radio devices. In the example, radio source 30M broadcasts on channel 8, and radio source 30N broadcasts on channel 3. Each radio source 30 has a transmission distance or range 31, shown as 31M and 31N, respectively.

As indicated, mobile devices 28t and 28r are within transmission range 31M of radio source 30M, and mobile device 28x is located within range 31N of radio source 30N. Accordingly, if there is channel conflict or significant overlap, one or both of radio sources 30M and 30N may interfere with the quality of service provided to these mobile devices.

According to the present invention, auto-correction, i.e., changing in order to optimize, of at least one of the transmission channels and/or other transmission parameters of the various access points is provided. It will be appreciated that this auto-correction is both automatic, upon triggering by pre-set triggers, and self-correction, as the access point can indicate that the channel it is transmitting over is no longer optimum. This auto-correction procedure is triggered either by a timeout, i.e., a predetermined period of time has passed since the previous procedure, or by a system event, i.e., wherein a change in the network produces a decrease in quality of service above a predefined threshold, such as addition of an access point, loss of service from an access point, interference from radio sources not part of the network, etc. In other words, these changes can cause the Quality of Service in this area to deteriorate, packet loss and jitter ratio to increase, and the noise-signal ratio to change. It is possible to estimate those parameters utilizing data received from the client devices, and preferably also utilizing data received from an access point.

The auto-correction procedure of wireless network 20, according to some embodiments of the invention, involves an active monitoring or maintenance test or scan that helps determine whether each access point is transmitting on the best available channel in its coverage area and using the best transmission parameters, in view of current network conditions. The maintenance test is carried out using the system access points 22 and one or more of the mobile devices 28 that happen to be in circulation within the region covered by network 20 at the time. In order to be used by the system for scanning, in addition to being located within the test region, mobile device 28 must be turned on but not in use in conversation. For example, a PDA or laptop computer or any other device with WiFi/WiMAX® capability that is turned on, but that is not being used for wireless communication, may be used in this way by the system. These devices 28 may be utilized as sensors by server 24, using the software that is installed in each mobile device 28 for this purpose.

Wireless network 20 typically includes several local auto-correction servers, each coupled to its own group of Access Points. For ease of description, only one local auto-correction server 24 is shown. In addition, network 20 may include a central auto correction server 26, coupled to a plurality of the local auto-correction servers 24, to receive and analyze data from the various local auto-correction servers 24. The central auto-correction server may also be used for initialization of the auto-correction procedure and for common results analysis. The central auto-correction server also acts as a central DBMS, to maintain a log of data and for later analysis.

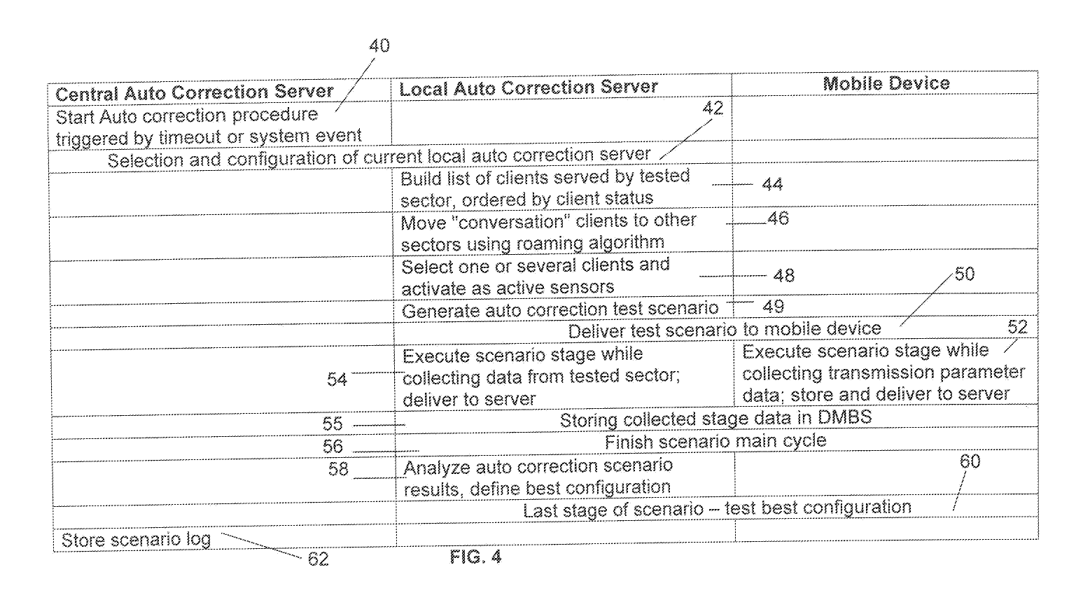

With reference to the flow chart of FIG. 4, a method for auto-correction, in accordance with some embodiments of the invention, is illustrated schematically. The maintenance test or scan for a particular access point may be conducted as follows:

Typically, the auto-correction procedure is triggered (block 40) by a timeout and/or a system event and the central auto-correction server initiates the procedure. The central auto-correction server and/or the local auto-correction server selects and configures the local auto-correction server to perform the procedure (block 42). The selected local auto-correction server generates a list of clients (i.e., mobile devices) that are currently being serviced by the access point being tested (block 44). Preferably, the list is organized by client status—i.e., engaged in wireless communication or available to act as a sensor.

All detected clients or mobile devices that are in use by their users are given a status of “conversation”, and are transferred to nearby access points (which are not implementing auto-correction at the time), using roaming algorithms (block 46), so as not to interfere with their communication while the access point being tested is in the maintenance mode. One or more (preferably two) of the remaining clients have their status changed to “active sensor” (block 47), depending on their location relative to the access point being tested. At least one such client should be available as an active sensor to perform the maintenance test.

The local auto-correction server now generates an auto-correct scenario for sector access point testing (block 48) and delivers the test scenario to the access point and, via the access point, to those mobile devices that are now acting as active sensors (block 49). The scenario includes a plurality of transmission channels for testing by the access point.

The main cycle of the test scenario is now initiated in the mobile devices (block 50). According to the previously generated scenario, the active sensors perform a first stage of the testing procedure by collecting data relating to the transmission parameters of the transmission from the access point on a particular channel from the radio frequency (RF) environment and Quality of Service parameters (block 52). These data are delivered to the local auto-correct server, typically via the access point, and may also be stored in the mobile device. For example, this can be accomplished by transmitting by UDP (User Datagram Protocol) or TCP (Transmission Control Protocol) to the server thru the access point being tested over a selected channel, enabling both the active sensor and the access point to calculate basic QoS parameters such as: packet loss, jitter and signal to noise ratio (SNR). The calculated data are transferred to the local auto correction server, either during or after the test transmissions, and stored in the Data Base Management System (block 55).

At the end of the first stage of the testing procedure, the local auto-correction server performs access point configuration modification, and initializes the next stage of the testing scenario performed by the active sensors by transmitting over a next channel. Optionally, the local auto-correction server may also collect similar data from the access points in its network segments.

By the end of the main cycle of the testing scenario, i.e., after all the selected transmission channels have been tested (block 56), the local auto-correction server has received the set of testing data, formed from various data received at all stages of the testing scenario. The local auto-correction server now analyzes the received data (the scenario results) in order to determine the optimal configuration for the tested access point to achieve the best performance under current network conditions (block 58).

As a final step in the scenario, the optimal configuration is transferred to the tested access point and a test of the optimal configuration is performed using all active sensors (block 60) to confirm that this configuration is, indeed, optimal under current network conditions. When it is determined whether the calculated configuration is, indeed, the best configuration, upon conclusion of the described procedure, a log of the data resulting from the performed scenario is saved on the central auto correction server (block 62), if present, and the system returns to regular operation mode.

The above procedure is repeated for all access points. An order of execution and timing of auto correction procedure is determined by the central auto correction server. It will be appreciated that one local auto-correction server can overlap testing of several network segments, and a number of such servers can operate in parallel to test several network sections at the same time.

The above auto-correction test preferably is conducted periodically by the system. In some embodiments, this procedure is repeated every 1 to 2 hours. The time between monitoring may be extended or shortened by the system, according to the results of a particular test. For example, if the test finds that the best channel is the same as or a channel close to the present channel, the next test may be conducted after a longer period of time, while if the best channel is quite different from the present channel, the next test will be conducted after a shorter period of time.

In addition to the periodic test procedures explained above, a system can be initialized to perform the auto-correction procedure in case of any pre-defined event. Such an event can be due to several reasons, like low QoS on any sector, or sudden disconnection of a number of clients from any sector, etc.

In the example of FIG. 2, as noted, radio source 30M introduces wireless transmission on channel 8 in the area defined by 31M, which is within the broader area defined by 23A of access point 22A, that broadcasts on channel 2. Similarly, radio source 30N broadcasts on channel 3 in the area defined by 31N, which is within the broader area defined by 23B of access point 22B, that broadcasts on channel 5. From the reference chart of FIG. 5, it may be seen that channel 8 does not overlap channel 2 and has little overlap with channel 5. Similarly, channel 3 has little overlap with channel 5 and no overlap with channel 10, transmitted by access point 22C. Accordingly, when the above maintenance test is run, it is likely that the system or network 20 of the present invention will determine that there is minimal interference, that quality of service is not seriously compromised, and the transmission channels will not be changed.

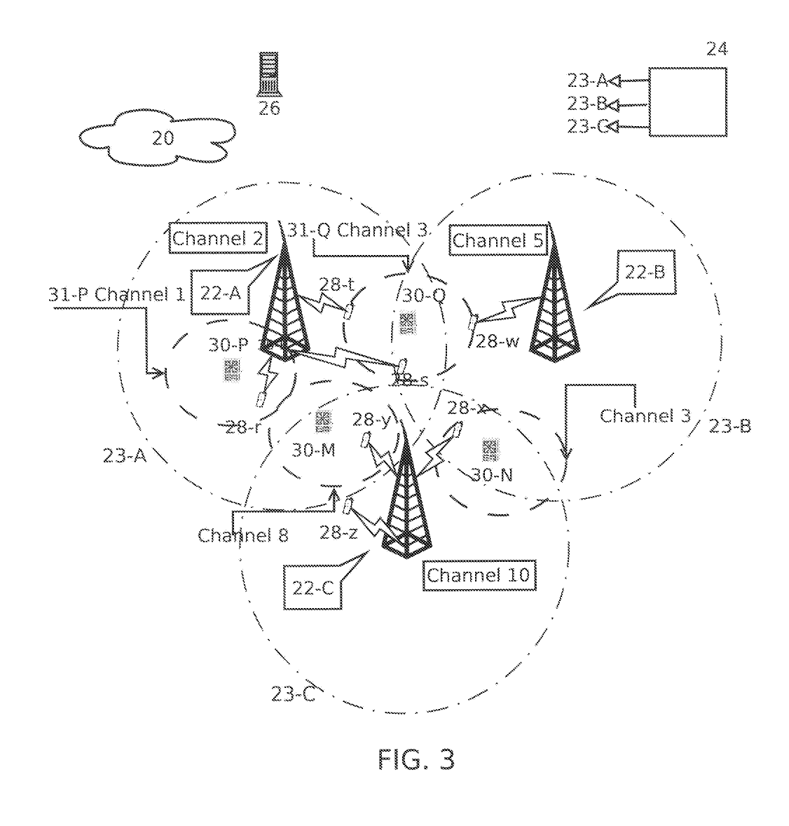

In another example, shown in FIG. 3, two new radio sources are now present-radio source 30P, defining transmission range 31P and broadcasting on channel 1, and radio source 30Q, defining transmission range 31Q and broadcasting on channel 3. Radio sources 30P and 30Q are within the transmission region of access point 22A, which broadcasts on channel 2. Further, it can be seen that mobile device 28s is within all three regions, and accordingly receives wireless signals on channels 1, 2, and 3 simultaneously. From the reference chart of FIG. 5, it may be seen that channels 1, 2, and 3 together have a substantial amount of overlap. Accordingly, it is likely that in this case, the maintenance test will show a marked reduction in Quality of Service in the region around mobile device 28s, in transmissions from access point 22A, due to interference from radio sources 30P and 30Q, and will determine an alternative channel and/or other alternative transmission parameters to be used by access point 22A.

The above auto-correction procedure also can be used when originally setting up wireless network 20, during the process of deployment and preliminary configuration. For example, in the case shown in FIG. 1, the test is used to determine that in order to achieve the best possible working result from the three installed access points 22, the appropriate working radio channels are 2, 5 and 10.

In addition to the periodic application of the maintenance test, in some embodiments of the invention, the test will also be run in between scheduled times in case there is a system event that requires testing of the network configuration.

According to additional embodiments of the invention, a triggering event can be identified using data collected by various mobile devices. For this purpose, mobile devices 28 that are turned on but not in use in conversation and are not needed for active testing are placed by the system in a “passive sensor” mode. In this mode, the devices 28 receive information from their surroundings about the number and identity of access points 22 in their vicinity, the distance to each access point 22, the channel on which each is transmitting, and the strength of transmission from each access point 22. This information is sent every few seconds to the local auto-correction server 24 with which the particular device is currently in communication, typically via the access point. Local auto-correction server 24 accumulates this data in a log and, after a pre-selected number of scans, uploads the log to its associated central auto-correction server 26, which analyzes the data. When this data indicates occurrence of one of the pre-defined events or a drop in quality of service with respect to a particular access point 22, the central auto-correction server 26 will initiate a test of the access point as described above, so that the problem, if present, can be corrected with little or no drop in service to the mobile client.

If a problem is found, the system tests to see what other channels may be used that are empty or generally available, and replaces the current channel that is experiencing interference with an available channel.

It will be appreciated that, instead of the system containing an independent server, the functions of the local auto-correction server described above can be performed by a module in one or more access points.

While the invention has been described with respect to a limited number of embodiments, it will be appreciated that many variations, modifications and other applications of the invention may be made. It will further be appreciated that the invention is not limited to what has been described herein above merely by way of example. Rather, the invention is limited solely by the claims which follow.

1. A system for management of radio frequency channels in a wireless communication network having at least one access point providing wireless access communication to mobile devices, the system comprising:
a local auto-correction server coupled for two-way communication to the at least one access point; and
at least one mobile device wirelessly coupled to said access point, said at least one mobile device having a software application selectively causing said mobile device to collect transmission parameter data of transmissions from an access point being tested and transferring said data to said auto-correction server;
said local auto-correction server including a processor for processing said data received from said at least one mobile device and for determining therefrom at least one optimal transmission parameter for said access point.

2. The system according to claim 1, comprising a plurality of said local auto-correction servers and further comprising a central auto-correction server, having a Data Base Management System (DBMS) installed, coupled to each of said local auto-correction servers.

3. The system according to claim 1, wherein said software application includes means for selectively causing said mobile device to collect identification, channel number and received signal strength data from access points in its vicinity and transmit said access point data to said auto-correction server.

4. The system according to claim 1, wherein said auto-correction server is mounted remotely from said access points.

5. The system according to claim 1, wherein said auto-correction server is mounted in at least one of said access points.

6. A method for management of radio frequency channels in a wireless communications network including at least one access point and at least one mobile device coupled for two-way wireless communication to said access point, the method comprising:
receiving, in an auto-correction server, transmission parameter data relating to transmissions from an access point collected by at least one mobile device receiving said transmissions;
processing said data in said server for determining at least one optimized transmission parameter of said access point; and
configuring said access point according to said optimized transmission parameter.

7. The method according to claim 6, further comprising:
collecting, in said at least one mobile device, at least identification, channel number and received signal strength data of nearby access points;
receiving, in said server, said identification, channel number and received signal strength data collected by said at least one mobile device; and
processing said data to identify a triggering event for auto-correction.

8. The method according to claim 6, wherein said step of receiving transmission parameter data includes:
generating a transmission channel testing scenario which includes a plurality of transmission channels for testing for said access point;
transmitting data between said access point and said mobile device over each transmission channel according to said scenario;
collecting transmission parameters relating to each said data transmission in said mobile device over each said transmission channel;
determining transmission parameters from said scenario having best Quality of Service (QoS) parameters; and
reconfiguring said access point to transmit using said determined transmission parameters.

9. The method according to claim 7, wherein said step of receiving transmission parameter data includes:
generating a transmission channel testing scenario which includes a plurality of transmission channels for testing for said access point;
transmitting data between said access point and said mobile device over each transmission channel according to said scenario;
collecting transmission parameters relating to each said data transmission in said mobile device over each said transmission channel;
determining transmission parameters from said scenario having best Quality of Service (QoS) parameters; and
reconfiguring said access point to transmit using said determined transmission parameters.

10. The method according to claim 6, further comprising collecting, in said access point being tested, transmission parameter data relating to said transmissions from said access point and transferring said data from said access point to said auto-correction server.
